(19) United States
(12) Patent Application Publication
(10) Pub. No.: US 2026/0138904 A1
(43) Pub. Date: May 21, 2026

(54) SYSTEM AND METHOD FOR PROCESS WATER AND OXIDE COATING RECOVERY AND DISTRIBUTION

(71) Applicant: Midrex Technologies, Inc., Charlotte, NC (US)

(72) Inventors: Jack Wilder, Charlotte, NC (US); Briant A. Wilder, Charlotte, NC (US)

(21) Appl. No.: 18/953,655

(22) Filed: Nov. 20, 2024

(51) Int. Cl. C02F 9/00; C02F 1/42; C02F 1/44; C02F 1/52; C02F 1/66; C02F 103/10; C02F 103/36

(52) U.S. Cl. CPC C02F 9/00; C02F 1/42; C02F 1/441; C02F 1/444; C02F 1/5236; C02F 1/66; C02F 2103/10; C02F 2103/365; C02F 2209/06

(57) ABSTRACT

A system and method for process water and oxide coating recovery and distribution in a direct reduction system, such as a system for producing direct reduced iron. A warm lime softener is used to remove (recover) calcium, alkalinity, and other constituents from the process water system and to produce an effluent that can be further processed and returned as makeup to the process water system. The lime softening process requires lime (or similar material) to be added to the influent, thereby increasing the calcium and pH levels until they become supersaturated and precipitate. This chemical process results in effluent that is low in calcium, alkalinity, and total suspended solids.

### TECHNICAL FIELD

The present disclosure relates generally to a system and method for process water (PW) and oxide coating recovery and distribution in a direct reduction (DR) system, such as a system for producing direct reduced iron (DRI).

### BACKGROUND

Oxide coating is necessary to prevent oxide pellets from sticking together in a DRI shaft furnace. Although several materials are suitable for preventing oxide pellets from sticking together (known as clustering), it is most common for hydrated lime, pulverized limestone, calcium carbonate, or some other calcium or magnesium-based material to be used. Depending on the DRI production capacity of the shaft furnace, 10-15 metric tons of lime (or similar material) may be consumed each day. As coated oxide pellets enter the top of the shaft furnace, a high volume of reducing gas flows countercurrent and lifts the iron oxide dust and coating material from the pellets and into the top gas scrubber (TGS). The TGS uses PW to wash the gas stream and clean it before the top gas is reused. Oxide coating material, iron dust, and other solids dissolve in the PW and increase the calcium, alkalinity, iron, pH, and total suspended solids (TSS). Essentially, a portion of the oxide coating material solubilizes in the PW system.

It is typically desirable, and sometimes mandated by regulatory requirements, for a plant operator to recover/recycle this oxide coating material (lime or the like) for subsequent oxide pellet coating (or other uses), as well as to recover/recycle the PW for use in the TGS or the like.

The reuse of blowdown from a DRI PW cooling tower (CT) has been attempted, but encountered a myriad of operational issues due to poor pretreatment of the blowdown prior to reverse osmosis. In this case, the pretreatment scheme was oxidation with ozone., to precipitate iron, followed by multimedia filtration followed by cartridge filtration. The resulting PW quality was insufficient to consistently process through the reverse osmosis unit used. PW lime softening has not been used because lime is difficult to handle and many facilities are not equipped with lime handling equipment.

It will be readily apparent to those of ordinary skill in the art that this background is provided only as environmental context and should not be construed to be limiting in any manner. The concepts and principles may be implemented in other environmental contexts as well, without limitation.

### SUMMARY

The present disclosure provides a system and method for PW and oxide coating recovery and distribution in a DR system, such as a system for producing DRI. The concept is to use warm lime softener to remove (recover) the calcium, alkalinity, and other constituents from the PW system and to produce an effluent that can be further processed and returned as makeup to the PW system. The lime softening process requires lime (or similar material) to be added to the influent, thereby increasing the calcium and pH levels until they become supersaturated and precipitate. This chemical process results in effluent that is low in calcium, alkalinity, and TSS.

The result is a DR process that utilizes less lime or similar oxide coating material, recycling lime (or similar material) back to the oxide coating process. The result is also a DR process that utilizes less makeup PW, recycling PW back to the PW system. This could be used in an existing or new DR plant, potentially as a bolt on option where it is economically and/or regulatorily favorable.

Thus, the present disclosure utilizes warm lime softening of the entire PW stream. The entire PW stream goes through a PW clarifier to remove suspended solids, specifically iron, and through a second PW clarifier, as opposed to just the blowdown PW flow. This provides low PW TSS, calcium, and alkalinity, while significantly reducing blowdown and providing water savings.

In some embodiments, the present disclosure provides a system including a process water clarifier utilizing a warm lime softener operable for receiving process water from a gas scrubber system associated with a direct reduction shaft furnace and removing and recovering an oxide coating material from the process water by supersaturating and precipitating the oxide coating material out of the process water to form clarified process water, where the recovered oxide material is either used for subsequent oxide pellet coating or stored, and where the formed clarified process water is either recycled to the gas scrubber system or stored.

In some embodiments, the system further includes another process water clarifier disposed between the gas scrubber system and the process water clarifier utilizing the warm lime softener operable for removing suspended solids from the process water prior to the removing and recovering the oxide coating material from the process water. The suspended solids removed from the process water may include iron.

In some embodiments, the system further includes a multimedia filtration system operable for removing suspended solids from the process water subsequent to the process water clarifier utilizing the warm lime softener.

In some embodiments, the system further includes a membrane reverse osmosis system operable for removing dissolved solids from the process water subsequent to the process water clarifier utilizing the warm lime softener.

The process water clarifier utilizing the warm lime softener is operable for receiving a majority of the process water from the gas scrubber system, as opposed to a minority of the process water from the gas scrubber system received as a blowdown flow from a process water cooling tower.

The process water clarifier utilizing the warm lime softener is operable for providing a majority of the process water received from the gas scrubber system as the formed clarified process water either recycled to the gas scrubber system or stored.

In some embodiments, the present disclosure provides a method including receiving process water from a gas scrubber system associated with a direct reduction shaft furnace and removing and recovering an oxide coating material from the process water by supersaturating and precipitating the oxide coating material out of the process water to form clarified process water, where the recovered oxide material is either used for subsequent oxide pellet coating or stored, and where the formed clarified process water is either recycled to the gas scrubber system or stored.

In some embodiments, the method further includes removing suspended solids from the process water prior to the removing and recovering the oxide coating material from the process water. The suspended solids removed from the process water may include iron.

In some embodiments, the method further includes removing suspended solids from the process water subsequent to the removing and recovering the oxide coating material from the process water.

In some embodiments, the method further includes removing dissolved solids from the process water subsequent to the removing and recovering the oxide coating material from the process water.

The process water received from the gas scrubber system is a majority of the process water from the gas scrubber system, as opposed to a minority of the process water from the gas scrubber system received as a blowdown flow from a process water cooling tower.

A majority of the process water received from the gas scrubber system is provided as the formed clarified process water either recycled to the gas scrubber system or stored.

It will be readily apparent to those of ordinary skill in the art that components/steps/aspects of embodiments of the present disclosure may be included, omitted, or combined as desired in a given application, without limitation.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a flowsheet illustrating one embodiment of the system and method for PW and oxide coating recovery and distribution in a DR system of the present disclosure; and

FIG. 2 is a flowsheet illustrating another embodiment of the system and method for PW and oxide coating recovery and distribution in a DR system of the present disclosure.

It will be readily apparent to those of ordinary skill in the art that components/steps/aspects of embodiments of the present disclosure may be included, omitted, or combined as desired in a given application, without limitation.

### DETAILED DESCRIPTION

Again, the present disclosure provides a system and method for PW and oxide coating recovery and distribution in a DR system, such as a system for producing DRI. The concept is to use warm lime softener to remove (recover) the calcium, alkalinity, and other constituents from the PW system and to produce an effluent that can be further processed and returned as makeup to the PW system. The lime softening process requires lime (or similar material) to be added to the influent, thereby increasing the calcium and pH levels until they become supersaturated and precipitate. This chemical process results in effluent that is low in calcium, alkalinity, and TSS.

The result is a DR process that utilizes less lime or similar oxide coating material, recycling lime (or similar material) back to the oxide coating process. The result is also a DR process that utilizes less makeup PW, recycling PW back to the PW system. This could be used in an existing or new DR plant, potentially as a bolt on option where it is economically and/or regulatorily favorable.

Thus, the present disclosure utilizes warm lime softening of the entire PW stream. The entire PW stream goes through a PW clarifier to remove suspended solids, specifically iron, and through a second PW clarifier, as opposed to just the blowdown PW flow. This provides low PW TSS, calcium, and alkalinity, while significantly reducing blowdown and providing water savings.

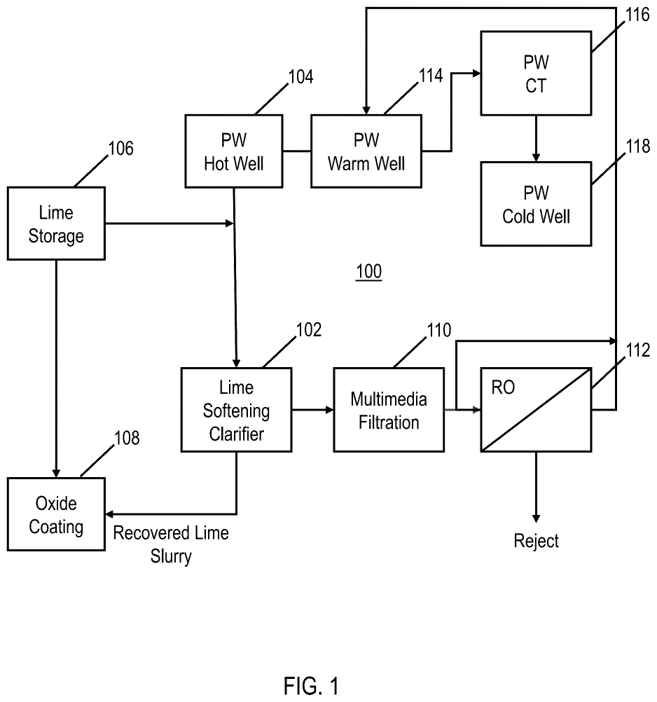

Referring to FIG. 1, the PW and oxide coating recovery and distribution system/method 100 includes a lime softening clarifier 102 that receives PW from a PW hot well 104 and lime from a lime storage 106 to remove (recover) calcium, alkalinity, and other constituents from the PW. The lime softening clarifier 102 produces an effluent that is further processed and returned as makeup to the PW system. The lime softening clarifier 102 utilizes lime added to the influent, thereby increasing the calcium, alkalinity, and pH levels until they become supersaturated and precipitate. This chemical process results in an effluent that is low in calcium, alkalinity, and TSS. As mentioned above, lime is referenced here because it is most common for hydrated lime, pulverized limestone, calcium carbonate, or some other calcium or magnesium-based material to be used as an oxide pellet coating material, however, this same concept may be applied to other materials as well. The recovered lime slurry is then used for subsequent oxide coating 108.

The recovered PW undergoes multimedia filtration 110, which reduces the levels of TSS, followed by membrane reverse osmosis (RO) 112, which reduces the levels of total dissolved solids (TDS) within the PW, and which rejects a small fraction of the processed PW as waste. The remainder of the PW is passed to a PW warm well 114, a PW CT 116, and eventually stored in a PW cold well 118 for subsequent use in the PW system.

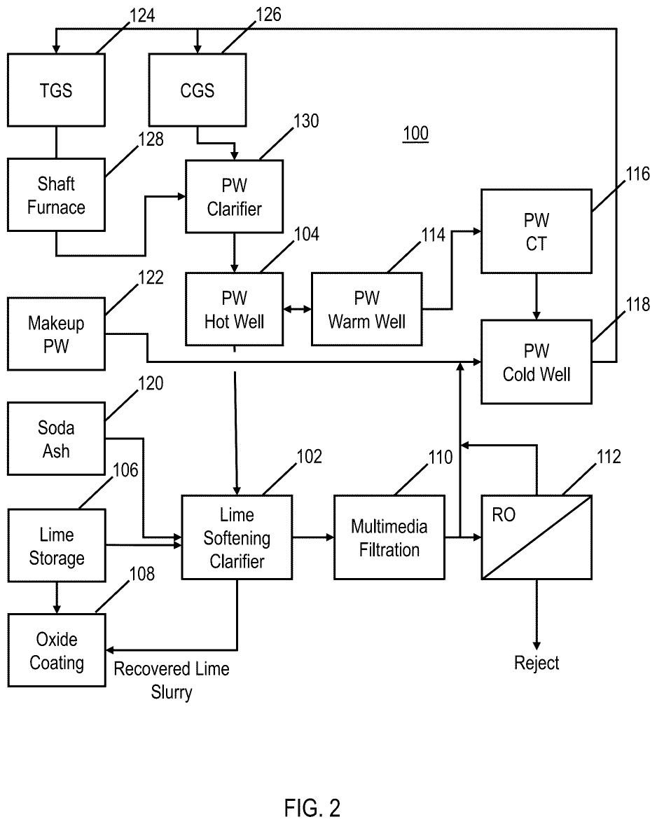

Referring to FIG. 2, the PW and oxide coating recovery and distribution system/method 100 again includes the lime softening clarifier 102 that receives PW from the PW hot well 104 and lime from the lime storage 106 to remove (recover) calcium, alkalinity, and other constituents from the PW. The lime softening clarifier 102 may also utilize soda ash from a soda ash source 120. Again, the lime softening clarifier 102 produces an effluent that is further processed and returned as makeup to the PW system. The lime softening clarifier 102 utilizes lime added to the influent, thereby increasing the calcium and pH levels until they become supersaturated and precipitate. This chemical process results in effluent that is low in calcium, alkalinity, and TSS. As mentioned above, lime is again referenced here because it is most common for hydrated lime, pulverized limestone, calcium carbonate, or some other calcium or magnesium-based material to be used as an oxide pellet coating material, however, this same concept may be applied to other materials as well. The recovered lime slurry is then used for subsequent oxide coating 108. Of note, during the operation of the lime softening clarifier 102, temperature control is important, and the temperature should be maintained between about 49 degrees C. and about 60 degrees C. to promote supersaturation and precipitation.

The recovered PW undergoes multimedia filtration 110, which reduces the levels of TSS within the PW, followed by membrane RO 112, which reduces the levels of TDS within the PW, and which again rejects a small fraction (10-20%) of the processed PW as waste. The remainder (80-90%) of the PW is passed to the PW cold well 118 after being combined with makeup PW from a makeup PW source 122, such as a desalinated water source. Typically, this makeup PW has about 25 ppm Cl⁻. The PW from the filtration processes 110, 112 has about 27 ppm Cl⁻, consisting of 40-50% PW from the multimedia filtration process 110 having about 25 ppm Cl⁻and 40-50% PW from the membrane RO process 112 having about 5 ppm Cl⁻. Thus, the PW stored in the PW cold well 118 has about 50 ppm Cl⁻. Again, PW from the PW hot well 104 and PW warm well 114 may be cooled over the PW CT and stored in the PW cold well 118.

The clarified PW from the above processes is utilized in the TGS 124 and cooling gas scrubber (CGS) 126 associated with the shaft furnace 128 and, after being used, is again processed through the PW clarifier 130 via the above processes. It should be noted that on the order of 15% of the oxide coating processed through the shaft furnace 128 ends up in the PW system.

Thus, again, the present disclosure provides a system and method for PW and oxide coating recovery and distribution in a DR system, such as a system for producing DRI. A warm lime softener is used to remove (recover) the calcium, alkalinity, and other constituents from the PW system and to produce an effluent that can be further processed and returned as makeup to the PW system. The lime softening process requires lime (or similar material) to be added to the influent, thereby increasing the calcium and pH levels until they become supersaturated and precipitate. This chemical process results in effluent that is low in calcium, alkalinity, and TSS.

The result is a DR process that utilizes less lime or similar oxide coating material, recycling lime (or similar material) back to the oxide coating process. The result is also a DR process that utilizes less makeup PW, recycling PW back to the PW system. This could be used in an existing or new DR plant, potentially as a bolt on option where it is economically and/or regulatorily favorable.

Thus, in some embodiments, the present disclosure provides a system and method utilizing a process water clarifier utilizing a warm lime softener operable for receiving process water from a gas scrubber system associated with a direct reduction shaft furnace and removing and recovering an oxide coating material from the process water by supersaturating and precipitating the oxide coating material out of the process water to form clarified process water, where the recovered oxide material is either used for subsequent oxide pellet coating or stored, and where the formed clarified process water is either recycled to the gas scrubber system or stored.

In some embodiments, the system and method further utilize another process water clarifier disposed between the gas scrubber system and the process water clarifier utilizing the warm lime softener operable for removing suspended solids from the process water prior to the removing and recovering the oxide coating material from the process water. The suspended solids removed from the process water may include iron.

In some embodiments, the system and method further utilize a multimedia filtration system operable for removing suspended solids from the process water subsequent to the process water clarifier utilizing the warm lime softener.

In some embodiments, the system and method further utilize a membrane reverse osmosis system operable for removing dissolved solids from the process water subsequent to the process water clarifier utilizing the warm lime softener.

The process water clarifier utilizing the warm lime softener is operable for receiving a majority of the process water from the gas scrubber system, as opposed to a minority of the process water from the gas scrubber system received as a blowdown flow from a process water cooling tower.

The process water clarifier utilizing the warm lime softener is operable for providing a majority of the process water received from the gas scrubber system as the formed clarified process water either recycled to the gas scrubber system or stored.

The systems and methods of the present disclosure are advantageous over conventional systems and methods in a number of respects. For example, related to the lime recovery disclosed in WO2019225256A1, PW from a clarifier and a CT is processed by a pre-filtering system and RO system to recycle to a PW system, where the mineral salt (mainly resolved Ca in this case) is removed by a salt-removal system (in this case RO) and the salt is recycled back to the iron oxide feed as a coating agent. The system/method of the present disclosure locates the lime PW clarifier comprising a warm lime softener upstream of the multi-media filtration and membrane RO to reduce the load and capex for such filtering systems. The prior art disadvantageously requires a large filtering system by design.

Although the present disclosure is illustrated and described with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following representative claims for all purposes, without limitation.

1. A system comprising:
a process water clarifier comprising a warm lime softener operable for receiving process water from a gas scrubber system associated with a direct reduction shaft furnace and removing and recovering an oxide coating material from the process water by supersaturating and precipitating the oxide coating material out of the process water to form clarified process water, wherein the recovered oxide material is either used for subsequent oxide pellet coating or stored, and wherein the formed clarified process water is either recycled to the gas scrubber system or stored.

2. The system of claim 1, further comprising another process water clarifier disposed between the gas scrubber system and the process water clarifier comprising the warm lime softener operable for removing suspended solids from the process water prior to the removing and recovering the oxide coating material from the process water.

3. The system of claim 2, wherein the suspended solids removed from the process water comprise iron.

4. The system of claim 1, further comprising a multimedia filtration system operable for removing suspended solids from the process water subsequent to the process water clarifier comprising the warm lime softener.

5. The system of claim 1, further comprising a membrane reverse osmosis system operable for removing dissolved solids from the process water subsequent to the process water clarifier comprising the warm lime softener.

6. The system of claim 1, wherein the process water clarifier comprising the warm lime softener is operable for receiving a majority of the process water from the gas scrubber system, as opposed to a minority of the process water from the gas scrubber system received as a blowdown flow from a process water cooling tower.

7. The system of claim 1, wherein the process water clarifier comprising the warm lime softener is operable for providing a majority of the process water received from the gas scrubber system as the formed clarified process water either recycled to the gas scrubber system or stored.

8. A method comprising:
receiving process water from a gas scrubber system associated with a direct reduction shaft furnace; and
removing and recovering an oxide coating material from the process water by supersaturating and precipitating the oxide coating material out of the process water to form clarified process water,
wherein the recovered oxide material is either used for subsequent oxide pellet coating or stored, and
wherein the formed clarified process water is either recycled to the gas scrubber system or stored.

9. The method of claim 8, further comprising removing suspended solids from the process water prior to the removing and recovering the oxide coating material from the process water.

10. The method of claim 9, wherein the suspended solids removed from the process water comprise iron.

11. The method of claim 8, further comprising removing suspended solids from the process water subsequent to the removing and recovering the oxide coating material from the process water.

12. The method of claim 8, further comprising removing dissolved solids from the process water subsequent to the removing and recovering the oxide coating material from the process water.

13. The method of claim 8, wherein the process water received from the gas scrubber system is a majority of the process water from the gas scrubber system, as opposed to a minority of the process water from the gas scrubber system received as a blowdown flow from a process water cooling tower.

14. The method of claim 8, wherein a majority of the process water received from the gas scrubber system is provided as the formed clarified process water either recycled to the gas scrubber system or stored.
